(19) United States
(12) Patent Application Publication
(10) Pub. No.: US 2025/0352890 A1
(43) Pub. Date: Nov. 20, 2025

(54) OPERATING DEVICE, METHOD FOR CONTROLLING OPERATING DEVICE, INFORMATION PROCESSING APPARATUS, AND PROGRAM

(71) Applicant: Sony Interactive Entertainment Inc., Tokyo (JP)

(72) Inventors: Sulgi HONG, Tokyo (JP); Hirotomo YUNOKI, Tokyo (JP); Yoshio MIYAZAKI, Tokyo (JP)

(73) Assignee: Sony Interactive Entertainment Inc., Tokyo (JP)

(21) Appl. No.: 18/871,170

(22) PCT Filed: Jun. 14, 2022
(86) PCT No.: PCT/JP2022/023846

§ 371 Date: Dec. 3, 2024

(51) Int. Cl. A63F 13/24

(52) U.S. Cl. CPC A63F 13/24

(57) ABSTRACT

There is provided an operating device having a tiltable operating member and a control circuit controlling the operating member. The control circuit restricts at least either a tiltable direction or a tiltable angle of the operating member according to the position of the operating member.

### TECHNICAL FIELD

The present invention relates to an operating device equipped with tilting operating members operated by being tilted by a user, a method for controlling the operating device, an information processing apparatus, and a program.

### BACKGROUND ART

There are known operating devices equipped with tilting members such as analog sticks operated by titling by the user. The user may perform operation input on the operating device to specify directions to an information processing apparatus, for example.

### SUMMARY

### Technical Problem

Generally, a tiling operating member is configured to be tiltable in any direction. Using the tilting operating members thus allows the user to perform operation input with a high degree of freedom. However, depending on the situation, it may not be appropriate to permit operation input with a high degree of freedom.

The present invention has been made in view of the above circumstances. An object of the present invention is therefore to provide an operating device permitting more diverse kinds of operation input by use of tilting operating members, a method for controlling such an operating device, an information processing apparatus, and a program.

### Solution to Problem

According to one embodiment of the present invention, there is provided an operating device including an operating member configured to be tiltably operated, and a control circuit configured to control the operating member. The control circuit restricts at least either a tiltable direction or a tiltable angle of the operating member according to a position thereof.

According to another embodiment of the present invention, there is provided an operating device including an operating member configured to be tiltably operated, and a control circuit configured to control the operating member. The operating member, in a case where no force is applied thereto, is pressed to a stop in a reference position. The control circuit restricts an operable range of the operating member to the range determined according to the reference position.

According to another embodiment of the present invention, there is provided a method for controlling an operating device having a tiltable operating member. The method includes acquiring position information regarding the operating member, and restricting either a tiltable direction or a tiltable angle of the operating member according to the acquired position information regarding the operating member.

According to another embodiment of the present invention, there is provided an information processing apparatus connected with an operating device having a tiltable operating member. The information processing apparatus includes at least one processor. The at least one processor acquires position information regarding the operating member. The at least one processor instructs the operating device to restrict at least either a tiltable direction or a tiltable angle of the operating member according to the acquired position information regarding the operating member.

According to another embodiment of the present invention, there is provided a program for causing a computer connected with an operating device having a tiltable operating member to execute acquiring position information regarding the operating member, and instructing the operating device to restrict at least either a tiltable direction or a tiltable angle of the operating member according to the acquired position information regarding the operating member. The program may be provided recorded on a computer-readable, non-temporary information storage medium.

### BRIEF DESCRIPTION OF DRAWINGS

FIG. 1 is a configuration block diagram depicting an overall configuration of an information processing system equipped with an operating device according to the present invention.

FIG. 2 is a view explaining a structure of a tilting operating member.

FIG. 3 is a view explaining an example of restriction control performed by the operating device according to the present invention.

FIG. 4 is a view explaining another example of restriction control performed by the operating device according to the present invention.

FIG. 5 is a view explaining an example of restriction control based on unit areas.

FIG. 6 is a view explaining an example of restriction control performed by the operating device according to the present invention in a case where a reference position of a columnar body is off the center position.

### DESCRIPTION OF EMBODIMENT

A preferred embodiment of the present invention is described below in detail with reference to the accompanying drawings.

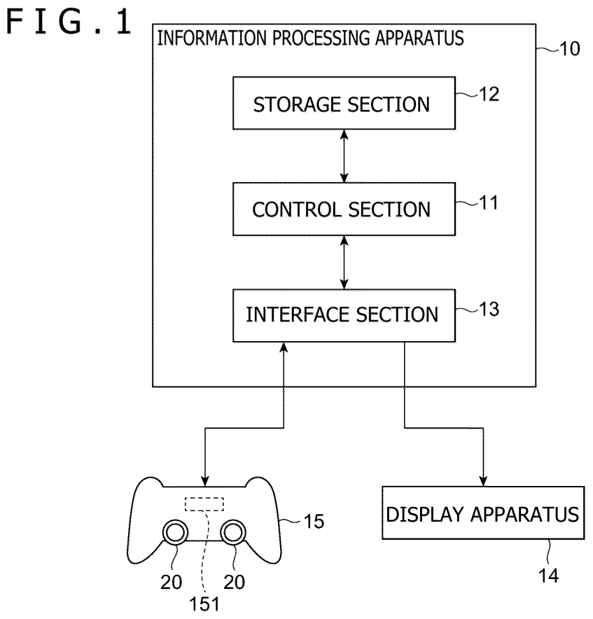

FIG. 1 is a configuration block diagram depicting an overall configuration of an information processing system equipped with an operating device 15 according to the present invention. The information processing system includes an information processing apparatus 10, a display apparatus 14, and the operating device 15.

The information processing apparatus 10 may be a home-use game machine, a handheld game console, or a personal computer, for example. As depicted in FIG. 1, the information processing apparatus 10 is configured to have a control section 11, a storage section 12, and an interface section 13. Also, the information processing apparatus 10 is connected with the display apparatus 14 and the operating device 15.

The control section 11 includes at least one processor such as a central processing unit (CPU), and performs various types of information processing by executing programs stored in the storage section 12. The storage section 12 includes at least one memory device such as a random access memory (RAM), and stores the programs to be executed by the control section 11 and the data to be processed by the programs.

The interface section 13 is an interface for data communication with the display apparatus 14 and the operating device 15. Through the interface section 13, the information processing apparatus 10 is connected with the display apparatus 14 and with the operating device 15 in a wired or wireless manner. Specifically, the interface section 13 is assumed to include a multimedia interface that transmits to the display apparatus 14 a video signal supplied from the information processing apparatus 10. The interface section 13 also includes a data communication interface for receiving signals indicative of details of operations performed by the user on the operating device 15. The interface section 13 may further include a communication interface for transmitting and receiving data to and from other communication devices via a communication network such as the Internet.

The display apparatus 14 may be a home-use television receiver, for example. The display apparatus 14 displays on its screen an image corresponding to the video signal supplied from the information processing apparatus 10.

The operating device 15 may be a controller of the home-use game machine, for example. The operating device 15 is equipped with multiple operating members for receiving operation input from the user. The operating device 15 is connected with the information processing apparatus 10 in a wired or wireless manner and transmits and receives various types of data thereto and therefrom.

The operating device 15 includes a control circuit 151 for controlling various sections. The control circuit 151 is configured to have a microcomputer, for example. The control circuit 151 scans details of operation input performed by the user on each operating member, and transmits an operation signal indicative of the scanned details to the information processing apparatus 10. Also, in response to the details of instructions received from the information processing apparatus 10, the control circuit 151 controls the states of tilting operating members 20, to be discussed later.

The operating device 15 of this embodiment has on its surface the tilting operating members 20 as one type of operating member. The tilting operating members 20 are each an operating member operated by being tilted by the user using hands and fingers. The tilting operating members 20 are each configured to be tiltable in any direction at 360 degrees. Incidentally, as a specific example, the operating device 15 is assumed here to have a pair of tilting operating members 20, i.e., a right-hand operating member 20 and a left-hand operating member 20. Holding the operating device 15 by both hands, the user can operate independently the left-hand tilting operating member 20 by the left thumb and the right-hand tilting operating member 20 by the right thumb.

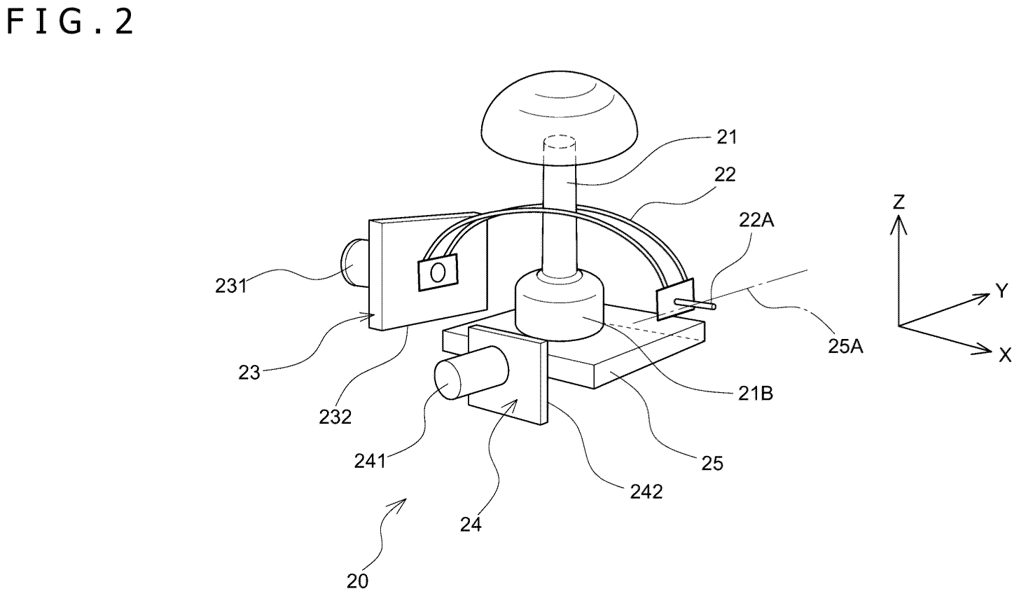

Explained below is a structure of the tilting operating member 20. As illustrated schematically in FIG. 2, a tilting operating member 20 is configured to have a columnar body 21 operated by tilting, a guide 22, a first actuator 23, a second actuator 24, and a base 25. Incidentally, it is assumed here that the guide 22 and the base 25 are supported rotatably around shafts 22A and 25A, respectively, at least within a predetermined angular range each. The direction of the shaft 22A is assumed to be the X-axis, and the direction of the shaft 25A is assumed to be the Y-axis. The direction perpendicular to both the X-axis and Y-axis is assumed to be the Z-axis. That is, the guide 22 is rotated inside a Y-Z plane around the shaft 22A. Also, the base 25 is rotated inside an X-Z plane around the shaft 25A.

The guide 22 restricts the movement of the columnar body 21 to one direction (X-axis direction). As described, the guide 22 is supported rotatably inside the Y-Z plane around the shaft 22A in a predetermined angular range. Also, this angular range is assumed to include an angular range in which the columnar body 21 becomes in parallel with the Z-axis direction.

The first actuator 23 and the second actuator 24 function as a drive section that drives the columnar body 21 as the principal component of the tilting operating member 20 in response to control signals received from the control circuit 151.

Specifically, the first actuator 23 is configured to have a motor 231 and a sensor 232. The motor 231 may be a three-phase brushless direct current (DC) motor (having 3n stators (n is a natural number)), for example. The first actuator 23 supplies a stator coil of each phase with a current input from the control circuit 151, to control the amount of rotation, rotational speed, and rotation direction of a rotor. The rotating shaft of the rotor in the motor 231 is coupled with the shaft 22A of the guide 22. The motor 231 thus rotates the guide 22 around the shaft 22A inside the Y-Z plane.

The sensor 232 may be an angle sensor such as a rotary encoder or a potentiometer, for example. The sensor 232 sequentially detects a tilt angle ec of the shaft 22A of the guide 22 with respect to a predetermined reference direction taken as 0 degrees (e.g., the direction of the guide 22 in which the columnar body 21 can be in the positive Z-axis direction). The sensor 232 outputs the result of the detection to the control circuit 151.

The second actuator 24 is configured to have a motor 241 and a sensor 242. As with the motor 231, the motor 241 may be a three-phase brushless DC motor, for example. The second actuator 24 supplies the stator coil of each phase with the current input from the control circuit 151 to control the amount of rotation, rotational speed, and rotation direction of the rotor. The rotating shaft of the rotor in the motor 241 is coupled with the shaft 25A of the base 25. The motor 241 thus rotates the base 25 around the shaft 25A inside the X-Z plane.

The sensor 242 may be an angle sensor such as a rotary encoder or a potentiometer, for example. The sensor 242 sequentially detects a tilt angle ϕc of the shaft 25A of the base 25 with respect to a predetermined reference direction taken as 0 degrees (e.g., the direction of the base 25 in which the columnar body 21 can be in the positive Z-axis direction). The sensor 242 outputs the result of the detection to the control circuit 151.

The base 25 is supported rotatably around the shaft 25A at least in a predetermined angular range. The base 25 supports a bottom 21B of the columnar body 21 in such a manner that, when the rotation angle of the base 25 is 0 degrees around the shaft 25A, the columnar body 21 is in the positive Z-axis direction.

The control circuit 151 includes two motor drivers: a motor driver that performs control to drive the motor 231 based on the result of the detection by the sensor 232, and a motor driver that executes control to drive the motor 241 based on the result of the detection by the sensor 242. Under drive instructions from the information processing apparatus 10, the control circuit 151 drives the motors 231 and 241 to carry out control to tilt the columnar body 21 in a desired direction at a desired angle and change the force necessary for tilting in a given direction. Also, the control circuit 151 detects information for identifying the tilt direction and tilt angle of the columnar body 21, and transmits periodically to the information processing apparatus 10 the detected information indicative of the details of operations performed by the user on the tilting operating members 20.

Incidentally, although not depicted in FIG. 2, there may be provided a clutch mechanism between the motor 231 and the guide 22 and also a clutch mechanism between the motor 241 and the base 25. In this case, the control circuit 151 controls the clutch mechanism between the motor 231 and the guide 22 to connect and disconnect power transmission from the motor 231 to the guide 22. The control circuit 151 also controls the clutch mechanism between the motor 241 and the base 25 to connect and disconnect power transmission from the motor 241 to the base 25. Also in this case, where power transmission from the motors 231 and 241 is disconnected, the columnar body 21 is assumed to be brought to the positive Z-axis direction by a spring, for example. Consequently, in a case where drive control is not performed on the motors 231 and 241, the control circuit 151 controls the clutch mechanisms to disconnect power transmission from each of the motors. This allows the user freely to perform the tilting operation of the columnar body 21 in any desired direction. When the user detaches the fingers from the columnar body 21, the columnar body 21 returns to the state of being in the positive Z-axis direction.

In the description that follows, in a state where the user applies no force to the columnar body 21, the position in which the columnar body 21 eventually stops will be referred to as the reference position of the tilting operating member 20. As described, in a case where the columnar body 21 is physically brought to a stop in the positive Z-axis direction with power transmission from the first actuator 23 and second actuator 24 disconnected by the clutch mechanisms, the position of the positive Z-axis direction becomes the reference position. The reference position may also be a position where the user does not perform operation input (i.e., where the amount of tilting operation by the user is 0). However, the reference position may not always coincide with the position of the positive Z-axis direction. The control in a case where the reference position does not coincide with the position of the positive Z-axis direction will be discussed later.

Also, the control circuit 151 may control the first actuator 23 and the second actuator 24 in such a manner as to let the tilting operating member 20 actively return to the reference position. In this case, both the mechanism of actuating the columnar body 21 and the clutch mechanisms are not mandatory. In such a case, with no operation input made by the user, the control circuit 151 performs drive control to move the columnar body 21 to the reference position with a predetermined amount of force. Once the columnar body 21 reaches the reference position, the control circuit 151 terminates the drive control. With such control continuously performed, the user is able to operate the tilting operating member 20 with an operational feeling similar to that in a case where the columnar body 21 is actuated to the reference position.

Under instructions from the information processing apparatus 10, the control circuit 151 in this embodiment performs control to restrict the tilt direction and tilt angle of the columnar body 21. The restriction control is explained below in detail.

Incidentally, in the description that follows, the tilting operating member 20 is assumed to be arranged in such a manner that the direction of tilting of the columnar body 21 by the motor 231 coincides with the horizontal direction of the operating device 15 and that the direction of tilting of the columnar body 21 by the motor 231 coincides with the front-back direction of the operating device 15. That is, the tilt angle ec of the shaft 22A detected by the sensor 232 represents the tilt of the columnar body 21 in the horizontal direction of the operating device 15, and the tilt angle ϕc of the shaft 25A detected by the sensor 242 denotes the tilt of the columnar body 21 in the front-back direction of the operating device 15. A set of these two tilt angle values (θc, ϕc) determines the position of the tilting operating member 20 (i.e., in which direction and at which angle the columnar body 21 is tilted).

Here, the angles θc and ϕc each take any value between a given maximum value and a given minimum value. That means the possible values taken by the set of (θc, ϕc) correspond to a rectangular area in a two-dimensional space. In the ensuing description, the range of the possible values taken by the set of the tilt angles will be referred to as the movable range of the tilting operating member 20. In practice, the maximum possible angle at which the tilting operating member 20 is physically tilted may be restricted by an enclosure of the operating device 15, for example, so that the physical movable range of the tilting operating member 20 may be circular. Still, the range of the possible values taken by the set of the detected tilt angles is considered here to be the movable range of the tilting operating member 20.

On the basis of given conditions, the control circuit 151 in this embodiment restricts a tiltable direction and/or a tiltable angle of the tilting operating member 20. For example, depending on the details of processing performed by the information processing apparatus 10, it may be desired to restrict the direction of the tilting operation to the front-back direction and suppress the tilting operation in the horizontal direction. In such a case, the information processing apparatus 10 gives the operating device 15 an instruction to suppress the tilting operation in the horizontal direction. In response to the instruction, the control circuit 151 of the operating device 15 controls the torque of the motor 221 to maximize the force necessary for rotating the columnar body 21 around the shaft 22A. This prevents the user from tilting the columnar body 21 in the horizontal direction and permits solely the operation of tilting it in the front-back direction. Note that the control circuit 151 may control both the motor 221 and the motor 231 to restrict the user's tilting operation in any direction.

Furthermore, the control circuit 151 may change details of restriction control according to the state of the tilting operating member 20. Specifically, the control circuit 151 may change the direction and/or the angle in and/or at which the tilting operation is restricted depending on the position of the columnar body 21 (i.e., current tilt direction and current tilt angle of the columnar body 21). This makes it possible for the user to diversely restrict the operable range of the columnar body 21, allowing the user's operational feeling to vary.

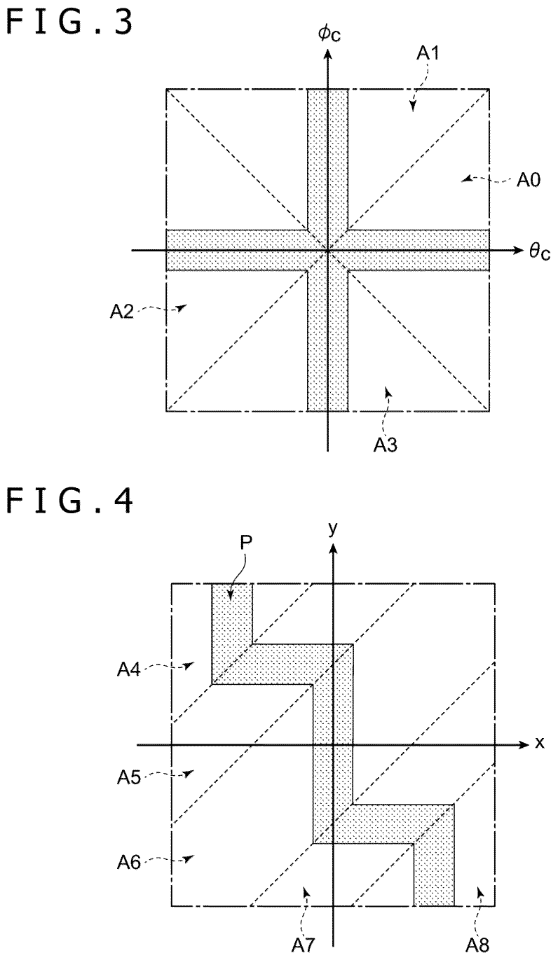

FIG. 3 is a view explaining an example of the above restriction control. This view depicts the case in which the tiltable range is restricted to the vertical and horizontal directions from the central position as indicated by shaded portions in the view. In this example, the movable range of the tilting operating member 20 indicated by dash-dotted lines is divided into four areas A0 to A3 by two broken lines intersecting with each other at the central position of the movable range. Then, the control circuit 151 performs restriction control in a manner not restricting the tilting operation in the horizontal direction in the areas A0 and A2 while suppressing the tilting operation in the vertical direction in these areas. Conversely, the control circuit 151 carries out restriction control in a manner not restricting the tilting operation in the vertical direction in the areas Al and A3 while suppressing the tilting operation in the horizontal direction in these areas. As a result, with the columnar body 21 at the central position, the user is able to tilt the columnar body 21 in four directions, i.e., up-down and right-left directions from the central position, while being prevented from making the tilting operation in oblique directions. Consequently, in a situation where the user is to select any one of panels arranged in a matrix pattern, for example, the user can specify any one of the up-down and right-left directions by using the tilting operating member 20 without experiencing feelings of discomfort.

FIG. 4 is a view explaining another example of the above restriction control. An objective of this example is to achieve an operational feeling similar to that of operating the shift lever of a car with manual transmission. More specifically, the user in this example is supposed to perform shift lever operations along a crank-shaped path P indicated by shaded portions in the view. The user achieves the shift lever operation along the path P by performing the tilting operation on the tilting operating member 20.

In the example in FIG. 4, the movable range of the tilting operating member 20 is divided into five areas A4 to A8 by four broken lines parallel with one another. Incidentally, unlike in the preceding example, the movable range of the tilting operating member 20 of this example is defined not by the set of tilt angles (θc, ϕc but by position coordinates (x, y) inside a two-dimensional plane. The position coordinates are obtained by projecting the position (i.e., tilt) of the columnar body 21 onto a projection plane (X-Y plane). The coordinate values on the two-dimensional plane are calculated as follows.

### X=tan θc

### Y=tan ϕc

By defining the areas using the coordinate positions on the projection plane, it is possible to make the operable range in which the tilting operating member 20 can be tilted correspond to a given range inside the plane.

In the example in FIG. 4, where the position of the columnar body 21 is included in the areas A4, A6, and A8, the control circuit 151 performs restriction control in a manner not restricting the tilting operation in the vertical direction (Y-axis direction) while suppressing the tilting operation in the horizontal direction (X-axis direction). In contrast, in a case where the position of the columnar body 21 is included in the areas A5 and A7, the control circuit 151 carries out restriction control in a manner not restricting the tilting operation in the horizontal direction (X-axis direction) while suppressing the tilting operation in the vertical direction (Y-axis direction). This allows the user to perform the operation of tilting the columnar body 21 along the path P while preventing the user from making the tilting operation of the columnar body 21 in a manner deviating from the path P. The user is thus able to experience the feeling of operating the shift lever with no feeling of discomfort.

As described, by changing the direction in which to restrict the tilting operation for each of the areas where the columnar body 21 is positioned, the control circuit 151 may set to a complex geometry the range in which the user can perform the tilting operation.

As explained above, in the case of performing control to restrict the possible direction in which to perform the tilting operation depending on the position of the columnar body 21, the control circuit 151 may carry out drive control in such a manner that the position of the columnar body 21 tilted by the user's operation also remains unchanged where the user is not performing any operation. In this case, during restriction control of the tilting operation, the control circuit 151 does not perform drive control to return the columnar body 21 to the above-mentioned reference position. Also, in a case where the columnar body 21 is physically pressed to the reference position by a spring, for example, the control circuit 151 may perform drive control to maintain the stationary state of the columnar body 21 against the pressing force.

In the examples above, it was explained that the geometries of the individual areas are determined according to the details of restriction. With this method, however, the individual areas may or may not have the same geometry or the same size. Depending on the details of restriction on the target operation range, there is a possibility that a specific process on the areas that include the columnar body 21 may become complex. In that case, the control circuit 151 may divide the movable range of the columnar body 21 into multiple unit areas and change the details of restriction on the direction of the tilting operation for each unit area.

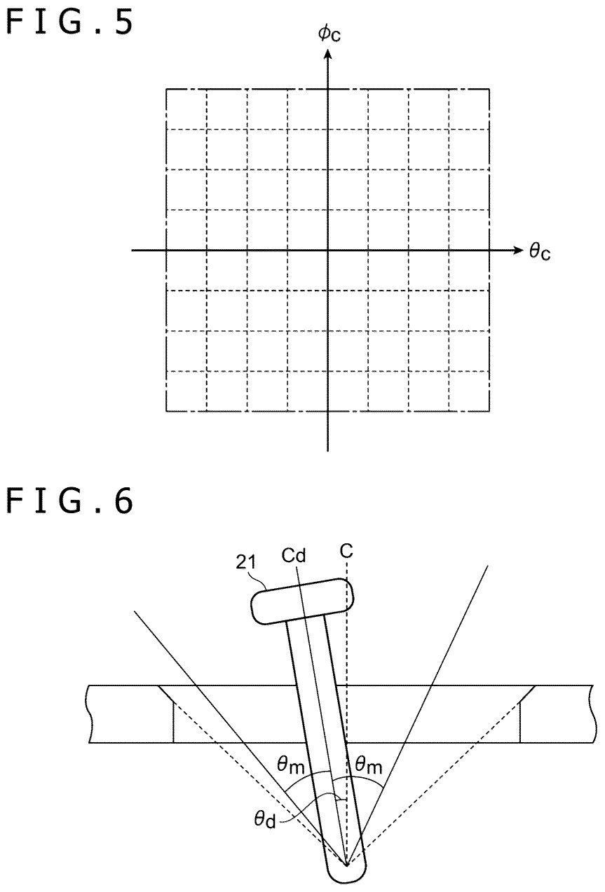

FIG. 5 depicts a specific example of unit areas in the case above. In the example in this view, as indicated by broken lines, multiple rectangular unit areas are established by dividing the movable range of the columnar body 21 into a grid-like pattern by multiple straight lines extending horizontally and vertically. These unit areas have the same geometry and the same size. The information processing apparatus 10 transmits to the operating device 15 a restriction instruction including information identifying the direction in which the operation is restricted with respect to each of the unit areas. Given the instruction, the control circuit 151 identifies a specific unit area that includes the position of the columnar body 21, and controls the motors 231 and 241 according to the details of control set for the identified unit area (i.e., direction in which the tilting operation is restricted), thereby restricting the user's tilting operation. Incidentally, whereas the unit areas are defined here by dividing the movable range represented by the set of the tilt angles (θc, ϕc), the unit areas may alternatively be defined as areas formed by diving the movable range inside the projection plane (X-Y plane).

The restriction control above makes it possible to apply restriction of different details to each of the unit areas, thereby enabling restriction of the movable range of the tilting operation to a more complex geometry. As a specific example, in an outer edge vicinity of the movable range of the columnar body 21, the control circuit 151 may restrict the operation of moving the columnar body 21 in directions toward the central position of the movable range, and may determine the details of control on each of the unit areas in a manner permitting the operation only in the direction along the outer periphery. Such control makes it easier for the user to perform the operation to rotate the columnar body 21 along the outer periphery of a circular movable range.

Incidentally, in the examples above, it was explained that the details of restriction on each of the areas formed by dividing the movable range of the tilting operating member 20 relate solely to restriction of the operable direction. However, this is not limitative of the details of restriction. Specifically, when the tilting operating member 20 is to be operated in each of the individual unit areas, the control circuit 151 may vary the amount of force necessary for performing the tilting operation depending on the direction of the operation. For example, in a case where the columnar body 21 is included in a given area, the control circuit 151 may perform control in such a manner that an upward tilting operation is possible but requires a larger amount of force than if the columnar body 21 is positioned in some other area whereas a downward tilting operation is possible with a smaller amount of force. This makes it possible to present the user with a feeling of a hitch halfway through tilting the lever in a specific direction, for example.

Also, the control circuit 151 may restrict not only the direction of the tilting operation but also the maximum tilt angle of the columnar body 21 tilted by the tilting operation. For example, the control circuit 151 may restrict the maximum tilt angle of the columnar body 21 to a value smaller than the physical maximum tilt angle thereof in order to limit the operable range of the columnar body 21 to a range narrower than the physical movable range thereof.

Furthermore, the control circuit 151 may restrict the maximum tilt angle to different values depending on the tilting direction. This makes it possible for the user to shift the operable range off the central position of the physical movable range. Such control permits establishment of the operable range centering on the reference position of the columnar body 21 even in a case where its reference position has deviated from the central position of the movable range, for example.

FIG. 6 is a view for explaining the control above, illustrating the movable range of the columnar body 21 as seen from a horizontal direction. In the example in this view, the columnar body 21 is assumed to be pressed to the central position of the physical movable range (described as the central position C hereunder) in a case where no force is applied from the outside such as from the user. It is assumed here that the central position C coincides with the position of the positive Z-axis direction. Ideally, in a case where the user is not touching the columnar body 21, the columnar body 21 should preferably be at a stop in the central position C. However, due to individual differences between devices, for example, a reference position Cd of the columnar body 21 (i.e., position in which the columnar body 21 is actually brought to a stop when the user is not touching the columnar body 21) may deviate from the central position C. FIG. 6 depicts, as an example, the reference position Cd of the columnar body 21 of this particular device deviating from the central position C to the left by a displacement angle ed.

In this example, the control circuit 151 identifies the reference position Cd of the columnar body 21, and, with the reference position Cd regarded as the center, restricts the maximum tilt angle in such a manner that the columnar body 21 cannot be tilted beyond an upper limit angle Om in any direction. Here, the upper limit angle θm is assumed to be smaller than the maximum angle of the physical movable range. In the example in FIG. 6, for example, where the displacement angle θd is 2 degrees and the upper limit angle θm is 26 degrees, the control circuit 151 restricts the maximum tilt angle of the columnar body 21 in such a manner that the maximum tilt angle to the left is 28 degrees with respect to the central position C(=θm+θd) and the maximum tilt angle to the right is 24 degrees relative to the central position C (=θm−θ). This makes it possible for the user to perform the tilting operation at the same angle θm in any direction from the reference position Cd of the columnar body 21 despite the reference position Cd deviating from the central position C. Consequently, the user is able to operate the tilting operating member 20 in the same angular range regardless of the individual device being used.

The control circuit 151 may also perform drive control in such a manner as to control the first actuator 23 and the second actuator 24 to actively return the columnar body 21 to the reference position as discussed above. In this case, too, the reference position need not necessarily coincide with the central position of the physical movable range of the columnar body 21. The control circuit 151 may change the reference position according to given conditions. Specifically, the control circuit 151 may change the reference position to a given position in response to instructions from the information processing apparatus 10.

For example, there may be a case where what takes place inside a virtual space is rendered by an application program executed by the information processing apparatus 10 and presented to the user and where an operation target object to be operated by the user is tilted with respect to a horizontal plane in the virtual space. In such a case, the information processing apparatus 10 issues instructions to change the reference position in a manner matching the tilt of the operation target object. In this manner, with no operation input performed by the user, the columnar body 21 is stopped in a state matching the posture of the operation target object in the virtual space. In this state, the user may perform an operation to further tilt the columnar body 21 in a desired direction from the reference position, thereby changing the posture of the operation target object.

Also, the control circuit 151 may change the reference position in keeping with the physique and preferences of the user using the operating device 15. For example, the control circuit 151 may set the reference position to a position tilted to the right as seen from the user for the tilting operating member 20 arranged on the right-hand side of the operating device 15 and operated by the user with the right thumb, and set the reference position to a position tilted to the left as seen from the user for the tilting operating member 20 arranged on the left-hand side of the operating device 15. This makes it easier for the user with relatively small hands to reach with fingers the columnar body 21 in the reference position. Consequently, the tilting operation from the reference position is easier to be performed. In this example, the information processing apparatus 10 may receive an instruction to change the reference position in advance from the user and transmit the details of the instruction to the operating device 15. Alternatively, the information processing apparatus 10 may acquire profile information (gender, age, etc.) regarding the user, and transmit to the operating device 15 an instruction to change the reference position according to the details of the acquired profile information.

Incidentally, as explained above, also in a case where the reference position is set actively to a position different from the central position under instructions from the information processing apparatus 10, for example, the control circuit 151 may change the maximum tiltable angle according to the reference position and the direction of the tilting operation. This makes it possible for the control circuit 151 to restrict the tiltable range to a desired range centering on the reference position. In this case, the control circuit 151 may evaluate the direction and amount of the tilting operation performed by the user, in reference to the reference position. That is, the control circuit 151 may transmit to the information processing apparatus 10 the direction and angle of the columnar body 21 as seen from the reference position as information indicative of the direction and amount of the tilting operation performed by the user.

As explained above, the operating device 15 of this embodiment can restrict the direction and/or the angle of the tiltable operation of the tilting operating member 20 in keeping with the position of the tilting operating member 20 (i.e., according to the tilting operation direction and the tilting operation angle of the columnar body 21 at this point), thereby allowing the user to perform the tilting operation in a variety of operable ranges.

Also, the operating device 15 of this embodiment can restrict the tiltable angle of the columnar body 21 according to the reference position in which no force is applied to the columnar body 21. This makes it possible to restrict the range in which the user can tilt the tilting operating member 20 in consideration of deviations of the reference position.

Note that the embodiment of the present invention is not limited thereto. The details of restriction control on the tilting operating member 20 in the foregoing description are only examples. The control circuit 151 may restrict in various manners the direction and the angle in and at which the tilting operating member 20 can be operated.

Further, the operating device 15 is not limited to the device held by the user by hand and may be a device placed on a desk for use, for example. The tilting operating member 20 is not limited to the operating member operated by the user using the thumb and may be any one of diverse operating members having various shapes and structures, such as an operating member operated with fingers other than the thumb or an operating member gripped by the user by hand.

Also, it was explained above that the control circuit 151 performs restriction control in keeping with the state of the tilting operating member 20. Alternatively, at least part of the above-described control executed by the control circuit 151 may be carried out by the information processing apparatus 10 connected communicably with the operating device 15.

Specifically, as described above, the operating device 15 periodically transmits to the information processing apparatus 10 the operation information indicating the details of the user's operations on each of the operating members of the operating device 15. The operation information includes information denoting the position of the tilting operating member 20 (i.e., tilt direction and tilting angle) as the information indicative of the details of the user's operations on the tilting operating member 20. In keeping with the current position of the tilting operating member 20, the information processing apparatus 10 determines the details of restriction on the direction and/or the angle of the tiltable operation of the tilting operating member 20, and transmits to the operating device 15 the instruction information instructing that the restriction be executed. According to the instruction information, the control circuit 151 of the operating device 15 controls the first actuator 23 and the second actuator 24 in a manner restricting the direction and/or the angle of the tiltable operation of the tilting operating member 20. In this configuration, information is exchanged between the operating device 15 and the information processing apparatus 10 in a relatively short cycle. This makes it possible to restrict the operable range of the tilting operating member 20 to a desired range.

### REFERENCE SIGNS LIST

10: Information processing apparatus

11: Control section

12: Storage section

13: Interface section

14: Display apparatus

15: Operating device

151: Control circuit

20: Tilting operating member

21: Columnar body

22: Guide

23: First actuator

24: Second actuator

25: Base

1. An operating device comprising:
an operating member configured to be tiltably operated; and
a control circuit configured to:
control the operating member, and
restrict-the control circuit restricts at least either a tiltable direction or a tiltable angle of the operating member according to a position of the operating member.

2. The operating device according to claim 1, wherein the control circuit is further configured to determine the restriction of either the tiltable direction or the tiltable angle of the operating member based on which one of a plurality of areas in an operable range of the operating member includes the position of the operating member.

3. The operating device according to claim 2, wherein at least some of the plurality of areas have an identical size and an identical geometry.

4. The operating device according to claim 2, wherein
the operating device is connected with an information processing apparatus, and
upon receipt, by the control circuit, of instruction information specifying an operable direction in each of the plurality of areas from the information processing apparatus, the control circuit is configured to restrict the tiltable direction of the operating member according to the direction specified by the instruction information regarding an area that includes the position of the operating member among the plurality of areas.

5. An operating device comprising:
an operating member configured to be tiltably operated; and
a control circuit configured to control the operating member, wherein the operating member, in a case where no force is applied to the operating member, is pressed to a stop in a reference position, and
the control circuit is further configured to restrict an operable range of the operating member to the range determined according to the reference position.

6. The operating device according to claim 5, wherein the control circuit is configured to restrict a tiltable angle of the operating member to the angle determined according to the reference position and the tiltable direction.

7. A method for controlling an operating device having a tiltable operating member, the method comprising:
acquiring position information regarding the operating member; and
restricting either a tiltable direction or a tiltable angle of the operating member according to the acquired position information regarding the operating member.

8. An information processing apparatus connected with an operating device having a tiltable operating member, the apparatus comprising:
at least one processor configured to:
acquire position information regarding the operating member, and
instruct the operating device to restrict at least either a tiltable direction or a tiltable angle of the operating member according to the acquired position information regarding the operating member.

9. A non-transitory computer readable medium comprising computer executable program code configured to instruct at least one computer to perform the following method:
acquiring position information regarding a tiltable operating member of an operating device; and
instructing the operating device to restrict at least either a tiltable direction or a tiltable angle of the operating member according to the acquired position information regarding the operating member.

10. The operating device according to claim 1, wherein the operating member includes:
a columnar body operated by tilting;
a guide;
a first actuator for driving the columnar member about an X-axis;
a second actuator for driving the columnar member about a Y-axis, the Y-axis being perpendicular to the X-axis; and
a base, and the control circuit is configured to restrict at least either the tiltable direction or the tiltable angle of the operating member by controlling the first actuator and the second actuator.

11. The operating device according to claim 10, wherein the guide and the base are rotatably supported around a first shaft extending in the X-axis and are rotatably supported around a second shaft extending in the Y-axis,
the first actuator is coupled to the first shaft and rotates the guide around the first shaft, and
the second actuator is coupled to the second shaft and rotates the guide around the second shaft.

12. The operating device according to claim 1, wherein the operating member, in a case where no force is applied to the operating member, is pressed to a stop in a reference position, and
the control circuit is further configured to restrict an operable range of the operating member to the range determined according to the reference position.

13. The operating device according to claim 5, wherein the operating member includes:
a columnar body operated by tilting;
a guide;
a first actuator for driving the columnar member about an X-axis;
a second actuator for driving the columnar member about a Y-axis, the Y-axis being perpendicular to the X-axis; and
a base, and
the control circuit is configured to restrict at least either a tiltable direction or a tiltable angle of the operating member by controlling the first actuator and the second actuator.

14. The operating device according to claim 13, wherein the guide and the base are rotatably supported around a first shaft extending in the X-axis and are rotatably supported around a second shaft extending in the Y-axis,
the first actuator is coupled to the first shaft and rotates the guide around the first shaft, and
the second actuator is coupled to the second shaft and rotates the guide around the second shaft.

15. The method according to claim 7, wherein the operating member includes:
a columnar body operated by tilting;
a guide;
a first actuator for driving the columnar member about an X-axis;
a second actuator for driving the columnar member about a Y-axis, the Y-axis being perpendicular to the X-axis; and
a base, and the method further comprises restricting at least either the tiltable direction or the tiltable angle of the operating member by controlling the first actuator and the second actuator.

16. The method according to claim 15, wherein the guide and the base are rotatably supported around a first shaft extending in the X-axis and are rotatably supported around a second shaft extending in the Y-axis,
the first actuator is coupled to the first shaft,
the second actuator is coupled to the second shaft, and the method further comprises:
rotating, by the first actuator, the guide around the first axis; and
rotating, by the second actuator, the guide around the second axis.

17. The method according to claim 7, further comprising:
pressing the operating member to a stop in a reference position, in a case where no force is applied to the operating member, is pressed to a stop in a reference position, and
restricting an operable range of the operating member to the range determined according to the reference position.

18. The information processing apparatus according to claim 8, wherein the operating member includes:
a columnar body operated by tilting;
a guide;
a first actuator for driving the columnar member about an X-axis;
a second actuator for driving the columnar member about a Y-axis perpendicular, the Y-axis being to the X-axis; and
a base, and
the control circuit restricts at least either the tiltable direction or the tiltable angle of the operating member by controlling the first actuator and the second actuator.

19. The information processing apparatus according to claim 18, wherein the guide and the base are supported rotatably around a first shaft extending in the X-axis and a second shaft extending in the Y-axis,
the first actuator is coupled to the first shaft and rotates the guide around the first shaft, and
the second actuator is coupled to the second shaft and rotates the guide around the second shaft.

20. The information processing apparatus according to claim 8, wherein the operating member, in a case where no force is applied to the operating member, is pressed to a stop in a reference position, and
the at least one processor is further configured to restrict an operable range of the operating member to the range determined according to the reference position.
